(19) United States
(12) Patent Application Publication
(10) Pub. No.: US 2022/0181640 A1
(43) Pub. Date: Jun. 9, 2022

(54) ELECTRODE AND LITHIUM-ION SECONDARY BATTERY MADE USING THE SAME

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/457,900

(22) Filed: Dec. 6, 2021

(30) Foreign Application Priority Data
Dec. 9, 2020 (JP) 2020-204163

(51) Int. Cl. H01M 4/76; H01M 4/66

(52) U.S. Cl. CPC H01M 4/762; H01M 4/666

(57) ABSTRACT

Provided are an electrode for lithium ion secondary batteries which can prevent cracking of the electrode, and a lithium ion secondary battery made using the same. An electrode (1, 2) for a lithium ion secondary battery (100) includes a collector (10, 20) of a metal porous body having a predetermined thickness, and having a corner of at least one location in a stereoscopic view; and an electrode mixture (18, 28) filled into these pores. The collector has a mixture filled region (11, 21) in which the electrode mixture is filled, and a mixture non-filled region (15, 25) in which the electrode mixture is not filled, or a high modulus filler having smaller elastic modulus than the electrode mixture is filled, existing at a corner of the collector.

This application is based on and claims the benefit of priority from Japanese Patent Application No. 2020-204163, filed on 9 Dec. 2020, the content of which is incorporated herein by reference.

### BACKGROUND OF THE INVENTION

### Field of the Invention

The present invention relates to an electrode and a lithium ion secondary battery made using the same.

### Related Art

Conventionally, lithium ion secondary batteries are widespread as a secondary battery having high energy density.

A liquid lithium ion secondary battery has a separator existing between the positive electrode and negative electrode, and has a cell structure filled with a liquid electrolyte (electrolytic solution). In addition, in the case of a solid-state battery in which the electrolyte is solid, it has a cell structure in which the solid electrolyte exists between the positive electrode and negative electrode. A plurality of this single cell is laminated to configure the lithium ion secondary battery.

Herein, in order to increase the filling density of electrode active material, it has been proposed to use a metal porous body as the collector constituting the positive electrode layer and the negative electrode layer (for example, refer to Patent Document 1). The metal porous body has a network structure with micropores, and large surface area. By filling the electrode mixture containing the electrode active material inside of this network structure, it is possible to increase the amount of active material per unit area of the electrode layer.
Patent Document 1: Japanese Unexamined Patent Application, Publication No. 2012-186139

### SUMMARY OF THE INVENTION

FIG. 7 is a schematic diagram according to an embodiment of a conventional lithium ion secondary battery, where FIG. 7A is a cross-sectional view, and FIG. 7B is a plan view. As shown in FIG. 7, a lithium ion secondary battery 500 is configured by the five layers of a negative electrode 51, solid electrolyte 54, positive electrode 52, solid electrolyte 54 and negative electrode 51. The number of layers is a number tentatively used for convenience of explanation, and the required number can be appropriately laminated. 512 and 522 are the tab converging parts of each electrode, and 513 and 523 are the tabs of each electrode.

FIG. 8 is an exploded cross-sectional view of a mixture filled region 511 of the negative electrode 51 in FIG. 7. The mixture filled region 511 of the negative electrode 51 is configured by a negative electrode collector 510 made using the above-mentioned metal porous body, and a negative electrode mixture 518 filled into the pores V₁ thereof. Similarly, the mixture filled region 521 of the positive electrode 52 is configured by the positive electrode collector 520 made using the above-mentioned metal porous body and the positive electrode mixture 528 filled in the pores V₁ thereof (figure numbers of the positive electrode shown in parenthesis).

The collectors of the metal porous body in the negative electrode 51 and positive electrode 52 are quadrangular columns of rectangular shape in a plan view as shown in FIG. 7B, from the viewpoint of increasing energy density. Then, due to being a three-dimensional stereoscopic structure having a network structure as a whole, it has a predetermined thickness, i.e. takes a substantially parallelepiped shape as a whole, except for the portions of the tab converging parts 512, 522. For this reason, corners A exist in the collector (at circled positions in FIG. 7).

Since the electrode mixture generally has very hard elastic modulus, if increasing the thickness of the collector in order to increase the energy density, it has been known that the electrode will tend to be fragile from vibration in the pressing process and after, etc. In FIG. 7A, the upper and lower plates P are pressing plates, and pressing is performed in the arrow directions in the drawing, by sandwiching from above and below by the plates P. In this case, cracking tends to occur at the corners A of the negative electrode collector 510 and position electrode collector 520, at which stress concentrates in particular. Since cracking of the electrode makes trouble such as a short circuit, there is a demand for improvement thereof. This cracking can occur in the liquid electrolyte; however, it is particularly remarkable in a solid-state battery using a solid electrolyte.

The present invention has been made taking the above into account, and has an object of providing an electrode which can effectively prevent cracking of the electrode particularly at the corners, and a lithium ion secondary battery made using this.

An electrode for lithium ion secondary batteries according to a first aspect of the present invention includes: a collector of a metal porous body having a predetermined thickness, and having a corner of at least one location in a stereoscopic view; and an electrode mixture filled into pores of the metal porous body,

in which the collector has a mixture filled region in which the electrode mixture is filled, and
a mixture non-filled region in which the electrode mixture is not filled, or a high modulus filler having an elastic modulus smaller than the electrode mixture is filled, existing at the corner of the electrode.

According to the first aspect of the present invention, by providing the mixture non-filled region at the corner of the collector, it is possible to mitigate stress at the corner and prevent cracking of the electrode, by the elasticity of the collector and the elasticity of the high modulus filler provided as necessary.

According to a second aspect of the present invention, in the electrode as described in the first aspect, the mixture filled region makes a curved surface at the corner of the collector.

According to the second aspect of the present invention, by making the apex of the mixture filled region into a curved surface, i.e. P shape, it is possible to mitigate stress at the corner and prevent cracking of the electrode.

According to a third aspect of the present invention, in the electrode as described in the first or second aspect, the high modulus filler is at least one selected from an insulating material, a reinforcing material and a thermal insulator.

According to the third aspect of the present invention, it is possible to improve the protective function of the corners of the collector in an electrical, strength and thermal manner, and possible to provide a solid-state battery of higher durability.

According to a fourth aspect of the present invention, in the electrode as described in any one of the first to third aspects, the mixture non-filled region is also present at an outer peripheral region of the collector.

According to the fourth aspect of the present invention, it is possible to mitigate the stress acting from the outer side of the outer peripheral region, in addition to corners of the collector, and possible to provide a solid-state battery of higher durability.

According to a fifth aspect of the present invention, in the electrode as described in any one of the first to fourth aspects, the mixture non-filled region is also present as an intermediate layer in the thickness direction of the collector.

According to the fifth aspect of the present invention, it is possible to mitigate the stress acting from the outer surface thickness direction of the collector by the intermediate layer, in addition to the corners of the collector, and possible to provide a solid-state battery having higher durability. A lithium ion secondary battery according to a sixth aspect of the present invention uses the electrode as described in any one of the first to fifth aspects as a positive electrode and a negative electrode, in which the positive electrode an electrolyte layer and the negative electrode are alternately arranged, and In the electrodes which are disposed to be adjacent, the shape and size of surfaces of the mixture filled regions opposing each area are substantially equal.

According to the sixth aspect of the present invention, by making the shape and area of the opposing mixture filled regions of adjacent electrodes to be matching, it is possible to improve the ion conductivity without waste, and possible to provide a solid-state battery of higher efficiency.

### BRIEF DESCRIPTION OF THE DRAWINGS

FIG. 1A is a schematic diagram according to a first embodiment of a lithium ion secondary battery of the present invention, and is a cross-sectional view;

FIG. 1B is a schematic diagram according to a first embodiment of the lithium ion secondary battery of the present invention, and is a plan view;

FIG. 2A is an enlarged cross-sectional view of a mixture filled region in FIG. 1;

FIG. 2B is an enlarged cross-sectional view of a mixture filled region in FIG. 1;

FIG. 3 is a cross-sectional schematic view according to a second embodiment of a lithium ion secondary battery of the present invention;

FIG. 4A is a plan view of a positive electrode in FIG. 3;

FIG. 4B is a cross-sectional view of the positive electrode in FIG. 3;

FIG. 5 is a cross-sectional schematic view according to a third embodiment of a lithium ion secondary battery of the present invention;

FIG. 6A is a modified example of a plan view of the positive electrode in FIG. 5;

FIG. 6B is a modified example of a cross-sectional view of the positive electrode in FIG. 5;

FIG. 6C is a modified example of a cross-sectional view of the positive electrode in FIG. 5;

FIG. 7A is a schematic view according to an embodiment of a conventional lithium ion secondary battery, and is a cross-sectional view;

FIG. 7B is a schematic view according to an embodiment of a conventional lithium ion secondary battery, and is a plan view; and

FIG. 8 is an enlarged cross-sectional view of a mixture filled region in FIG. 7.

### DETAILED DESCRIPTION OF THE INVENTION

Hereinafter, embodiments of the present invention will be explained while referencing the drawings. The contents of the present invention are not limited to the following descriptions of the embodiments.

The following embodiments explain an all solid-state lithium ion battery in which the electrolyte layer is solid as an example.

### First Embodiment

### <Overall Configuration of Lithium Ion Secondary Battery>

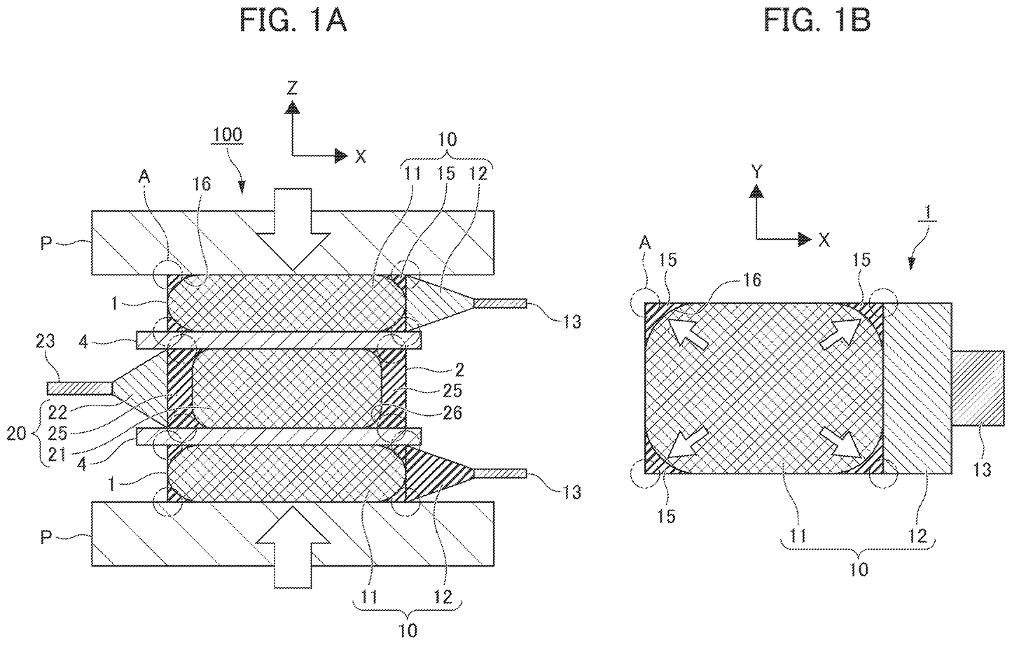

As shown in FIG. 1, in the lithium ion secondary battery of the present invention, the negative electrode 1 and positive electrode 2 are arranged to be alternatively laminated via a solid electrolyte layer 4. In other words, a single cell is a three-layer configuration of the negative electrode 1/solid electrolyte layer 4/positive electrode 2.

In the following embodiments, a so-called all solid-state battery made using a solid as the electrolyte will be explained as an example; however, it is not to be limited thereto, and the electrodes for lithium ion secondary batteries of the present invention can also be applied to lithium ion batteries made using a liquid as the electrolyte. Hereinafter, each configuration will be explained.

### <Positive Electrode and Negative Electrode>

The positive electrode and negative electrode constituting the battery can constitute any battery by selecting two types from among materials which can constitute electrodes, comparing the charge/discharge potentials of the two types of compounds, then using one exhibiting electropositive potential as the positive electrode, and one exhibiting electronegative potential as the negative electrode.

As shown in FIGS. 1A and B, the positive electrode 2 and negative electrode 1 are respectively configured by metal porous bodies having pores continuous with each other (communicating pores), and include a substantially rectangular positive electrode collector 20, negative electrode collector 10 in the plan view. It should be noted that, onward, the plan view of FIG. 1B is defined as the XY plane, and the cross-sectional view of FIG. 1A is defined as the XZ plane. In other words, the in-plane direction when regarding the electrode as a plate is the XY direction. An off-plane direction is a Z direction.

In the lamination state of FIG. 1A, a tab converging part 12, 22 which reduces in diameter is extending from the one end of the positive electrode collector 20, negative electrode collector 10, and a linear tab 13, 23 is connected to the end after this reduced diameter. In FIG. 1, the tab converging parts 12, 22 are regions in which the mixture is not filled.

In the pores of the positive electrode collector 20, negative electrode collector 10, the electrode mixture (positive electrode mixture) 28 and electrode mixture (negative electrode mixture) 18 containing the electrode active materials are each arranged by filling to configure the mixture filled regions 11, 21. Conversely, in the present invention, the mixture un-filled region in which the electrode mixture is not arranged by filling exists in the collector. This point will be described later.

### (Collector)

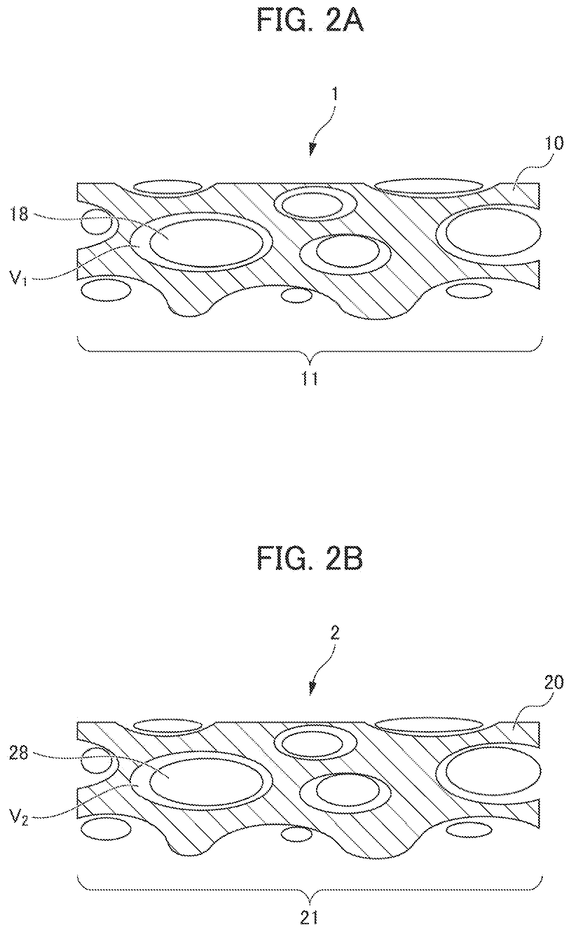

As schematically shown in FIGS. 2A and 2B, the positive electrode collector 20 and negative electrode collector 10 which are structures constituting the positive electrode and negative electrode are configured from a metal porous body having pores V₁ (negative electrode pores), V₂ (positive electrode pores) continuous with each other. By the positive electrode collector 20 and negative electrode collector 10 having pores which are continuous with each other, it is possible to respectively fill the positive electrode mixture 28, negative electrode mixture 18 containing electrode active material inside of the pores, and possible to increase the electrode active material amount per unit area of the electrode layer. The above-mentioned metal porous body is not particularly limited so long as having pores which are continuous with each other, and forms such as foam metal having pores by foaming, metal mesh, expand metal, perforated metal and metal nonwoven fabric can be exemplified, for example.

As the metal used in the metal porous body, it is not particularly limited so long as having electrical conductivity; however, nickel, aluminum, stainless steel, titanium, copper, silver, etc. can be exemplified, for example. Among these, as the collector constituting the positive electrode, foam aluminum, foam nickel and foam stainless steel are preferable, and as the collector constituting the negative electrode, it is possible to preferably use foam copper and foam stainless steel.

By using the positive electrode collector 20, negative electrode collector 10 of metal porous bodies, it is possible to increase the active material amount per unit area of the electrode, a result of which it is possible to improve the volume energy density of the lithium ion secondary battery. In addition, since immobilization of the positive electrode mixture 28 and negative electrode mixture 18 becomes easy, contrary to an electrode using a conventional metal foil as the collector, it is unnecessary to thicken the coating slurry forming the electrode mixture layer, upon thickening the electrode mixture layer. For this reason, it is possible to decrease the binding agent such as an organic polymer compound which has been necessary in thickening. Therefore, it is possible to increase the volume per unit area of electrode, and possible to realize a capacity increase of the lithium ion secondary battery.

(Electrode Mixture)

The positive electrode mixture 28, negative electrode mixture 18 are respectively arranged in the pores V1 (negative electrode pores) and V2 (positive electrode pores) formed inside of the positive electrode collector 20 and negative electrode collector 10. The positive electrode mixture 28, negative electrode mixture 18 respectively contain positive electrode active material and negative electrode active material as requisites.

(Electrode Active Material)

As the positive electrode active material, so long as being a material which can occlude and release lithium ions, it is not particularly limited; however, LiCoO₂, Li (Ni_{5/10}Co_{2/10}Mn_{3/10}) O₂, Li (Ni_{6/10}Co_{2/10}Mn_{2/10})O₂, Li (Ni_{8/10}Co_{1/10}Mn_{1/10})O₂, Li (Ni_{0.8}Co_{0.15}Al_{0.05})O₂, Li (Ni_{1/6}Co_{4/6}Mn_{1/6})O₂, Li (Ni_{1/3}Co_{1/3}Mn_{1/3})O₂, LiCoO₄, LiMn₂O₄, LiNiO₂, LiFePO₄, lithium sulfide, sulfur, etc. can be exemplified.

As the negative electrode active material, although not particularly limited so long as being able to occlude and release lithium ions, for example, it is possible to exemplify metallic lithium, lithium alloy, metal oxide, metal sulfide, metal nitride, Si, SiO, and carbon materials such as artificial graphite, natural graphite, hard carbon and soft carbon.

(Other Components)

The electrode mixture may optionally contain other components other than the electrode active material and ion conductive particles. The other components are not particularly limited, and may be components which can be used upon preparing a lithium ion secondary battery. For example, conductive auxiliary agent, binding agent, etc. can be exemplified. As the conductive auxiliary agent of the positive electrode, it is possible to exemplify acetylene black, etc., and as the binder of the positive electrode, it is possible to exemplify polyvinylidene fluoride, etc. As the binder of the negative electrode, it is possible to exemplify sodium carboxymethyl cellulose, styrene-butadiene rubber, sodium polyacrylate, etc.

(Manufacturing Method of Positive Electrode and Negative Electrode)

The positive electrode 2 and negative electrode 1 are obtained by filling the electrode mixture into the pores of the metal porous body having pores which are continuous with each other as the collector. First, the electrode active material, and further, the binder and auxiliary agents are further uniformly mixed by a conventionally known method, to obtain the electrode mixture composition of preferably paste form adjusted to a predetermined viscosity.

Next, the above-mentioned electrode mixture composition is filled, as the electrode mixture, into the pores of the metal porous body which is the collector. The method of filling the electrode mixture into the collector is not particularly limited, and a method which fills a slurry containing the electrode mixture inside of the pores of the collector with pressure using a plunger-type die coater can be exemplified. Other than the above, the ion conductor layer may be impregnated inside of the metal porous body by a dipping method.

(Electrolyte Layer)

The present embodiment uses a solid electrolyte layer 4; however, in the present invention, it may include a solid electrolyte which is an electrolyte of solid or gel form, or may include an electrolytic solution of liquid form made by dissolving the electrolyte in a non-aqueous solvent.

The solid electrolyte is not particularly limited; however, a sulfide-based solid electrolyte material, an oxide-based solid electrolyte material, a nitride-based solid electrolyte material, a halide-based solid electrolyte material, etc. can be exemplified. As the sulfide-based solid electrolyte material, LPS-based halogen (Cl, Br, I), Li₂S—P₂S₅, Li₂S—P₂S₅—LiI, etc. can be exemplified, so long as being a lithium ion battery, for example. It should be noted that the description of the above “Li₂S—P₂S₅” indicates a sulfide-based solid electrolyte material made using a raw material composition containing “Li₂S and P₂S₅” and also applies to other descriptions. As the oxide-based solid electrolyte material, it is possible to exemplify NASICON oxides, garnet-type oxides, perovskite-type oxides, etc., so long as being a lithium ion battery, for example. As the NASICON oxides, it is possible to exemplify oxides containing Li, Al, Ti, P and O (for example, Li_{1.5}Al_{0.5}Ti_{1.5}(PO₄)₃), for example. As the garnet-type oxide, it is possible to exemplify oxides containing Li, La, Zr and O (for example, Li⁷La₃Zr₂O₁₂), for example. As the perovskite-type oxide, it is possible to exemplify oxides containing Li, La, Ti and O (for example, LiLaTiO₃), for example.

The electrolyte dissolved in the non-aqueous solvent is not particularly limited; however, it is possible to exemplify, for example, LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂(LGPS), Li₃PS₄, Li₄PS₅Cl, Li₇P₂S₈I, LiₓPO_{y}N_{z}(x=2y+3z−5, LiPON), Li₇La₃Zr₂O₁₂ (LLZO), Li₃ₓLa_{2/3-x}TiO₃(LLTO), Li₁₊ₓAlₓTi₂₋ₓ(PO₄)₃ (0≤x≤1, LATP), Li_{1.5}Al_{0.5}Ge_{1.5} (PO₄)₃ (LAGP), Li_{1+x+y}AlₓTi_{2-z}Si_{y}P_{3-y}O₁₂, Li_{1+x+y}Alₓ (Ti,Ge)₂₋ₓSi_{y}Pa_{3-y}O₁₂, Li₄₋₂ₓZnₓGeO₄(LISICON), etc. The above may be used as one type individually, or may be used as two or more types by combination.

The non-aqueous solvent contained in the electrolytic solution is not particularly limited; however, it is possible to exemplify aprotic solvents such as carbonates, esters, ethers, nitriles, sulfones and lactones. More specifically, it is possible to exemplify ethylene carbonate (EC), propylene carbonate (PC), diethyl carbonate (DEC), dimethyl carbonate (DMC), 1,2-dimethoxy ethane (DME), 1,2-diethoxy ethane (DEE), tetrahydrofuran (THF), 2-methyltetrahydrofuran, dioxane, 1,3-dioxolane, diethylene glycol dimethyl ether, ethyleneglycol dimethyl ether, acetonitrile (AN), propionitrile, nitromethane, N,N-dimethylformamide (DMF), dimethyl sulfoxide, sulfolane, γ-butyrolactone, etc. The above may be used as one type individually, or may be used as two or more types by combination.

### (Separator)

The lithium ion secondary battery according to the present embodiment may include a separator in the case of using a liquid electrolyte in particular. The separator is located between the positive electrode and the negative electrode. The material, thickness, etc. thereof are not particularly limited, and it is possible to apply a well-known separator which can be used in lithium ion secondary batteries such as polyethylene and polypropylene.

### <Mixture Filled Region and Mixture Non-Filled Region>

Next, a mixture filled region 11 (21) and mixture non-filled region 15 (25) of the collectors which are features of the present invention will be explained. The figure numbers in parenthesis are examples of the negative electrode.

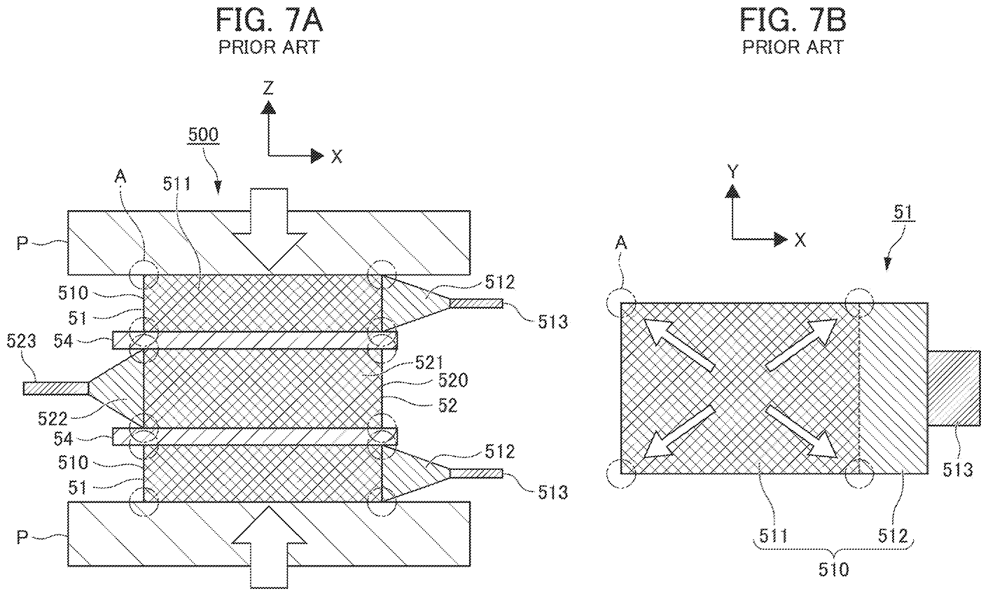

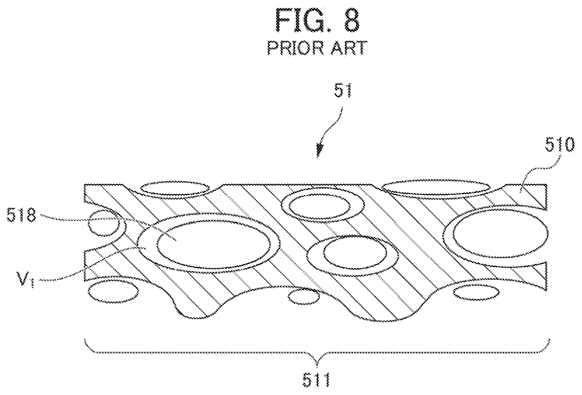

As shown in FIG. 7 as the above-mentioned conventional technology, the positive electrode collector 20 constituting the positive electrode 20 and the negative electrode collector 10 constituting the negative electrode 1 in FIGS. 1A and B make a substantially rectangular parallelepiped shape as a whole, when excluding the portion of the tab converging part 12 (22).

For this reason, corners A exist at the circled positions in the drawing. In this embodiment, the total of 8 corners A exist of the four at the top surface four corners and the four at the lower surface four corners in the XY plane of the electrode. It should be noted that the corners on the side of the tab converging part 12 constitute corners of the present invention here, since corners associated with the diameter reduction beginning of the tab converging part 12 in the X direction are present. In the present invention, “corner” is not only the apex configured by at least three planes, i.e. angular part, but also corresponds to the corner of the present invention in the case of the apex making an R-shaped curved surface.

In FIGS. 1A and B, the apex of the mixture filled region 11 (21) containing the electrode mixture 18, 28 in this corner A is chamfered to make the R-shaped curved surface part 26. As a result thereof, the mixture non-filled region 15 (25) is formed in the corner A. The positive electrode collector 20 is configured by the mixture filled region 21, mixture non-filled region 25 and tab converging part 22, and the negative electrode collector 10 is configured by the mixture filled region 11, mixture non-filled region 15 and tab converging part 12.

The mixture non-filled region 15 (25) is formed by a structure of only the collector having a space of a 3D network structure. For this reason, the mixture non-filled region 15 (25) has small elastic modulus compared to the mixture filled region 11 (21) made by filling the electrode mixture having large elastic modulus. As shown in FIGS. 1A and B, upon sandwiching and pressing from above and below directions (Z direction) by the plates P, the mixture filled region 11 (21) is rolled in the arrow direction of FIG. 1B in the XY plane, and stress concentrates at the corners A. At this time, since the mixture non-filled region 15 (25) acts as a buffer layer, it is possible to effectively prevent cracking of the electrode.

The mixture non-filled region 15 (25) may be provided to both the positive electrode 2 and negative electrode 1 as in this embodiment, or may be provided to only the required locations of either the positive electrode 2 and negative electrode 1. In addition, it may be provided to all corners A as in this embodiment, or may be provided to only one or a plurality of predetermined corners; however, since the corner on the opposite side to the tab converging part of the collector in a plan view tends to concentrate stress, it is preferable to be at least formed at this corner.

In addition, as in the mixture non-filled region 15 of the negative electrode 1 of FIG. 1A, the mixture non-filled region 15 may be formed so that the upper and lower two corners that are on the same line in the Z direction are continuous.

In addition, the total area of the negative electrode mixture filled region 11 and mixture non-filled region 15 is preferably substantially identical to the total area of the positive electrode mixture filled region 21 and mixture non-filled region 25. By setting both areas to be identical, it is possible to suppress bias of stress due to the surface pressure of the positive electrode and negative electrode becoming uniform, and prevent cracking, etc. It should be noted that, for Li electrodeposition prevention, it is preferable for the area of the positive electrode mixture filled region 21 to be smaller than the area of the negative electrode mixture filled area 11 facing each other, as shown in FIG. 1.

It should be noted that a high modulus filler having smaller elastic modulus than the electrode mixture, i.e. softer, may be filled in the mixture non-filled region 15 (25). In this case, when the high modulus filler is at least one selected from insulating material, reinforcing material and thermal insulator, it is possible to improve the protective function of the corners of the collector in an electrical, strength and thermal manner, and possible to provide a solid-state battery of higher durability. As specific examples of the high modulus filler, it is possible to exemplify resins, elastomers, etc. having lower elastic modulus than the electrode mixture. As the high modulus filler, the above-mentioned solid electrolyte may be contained. FIG. 1A is an example in which the high modulus filler is filled into the mixture non-filled region 15 (25). As described later, example in which the high modulus filler is not filled is distinguished by hatching in the illustrations.

In addition, the high modulus filler may be filled not only in the mixture non-filled region 15 (25) of the corner, but also the tag converging part 12. The negative electrode 1 arranged at the topmost part of FIG. 1A is an example in which the high modulus filler is not filled in the tab converging part 12, and the negative electrode 1 arranged at the bottommost part of FIG. 1A is an example in which the high modulus filler is filled in the tab converging part 12, and both are distinguished by hatching.

### Second Embodiment

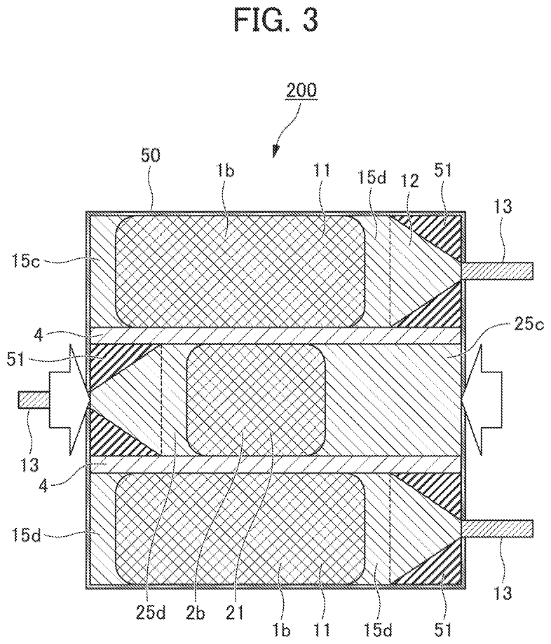

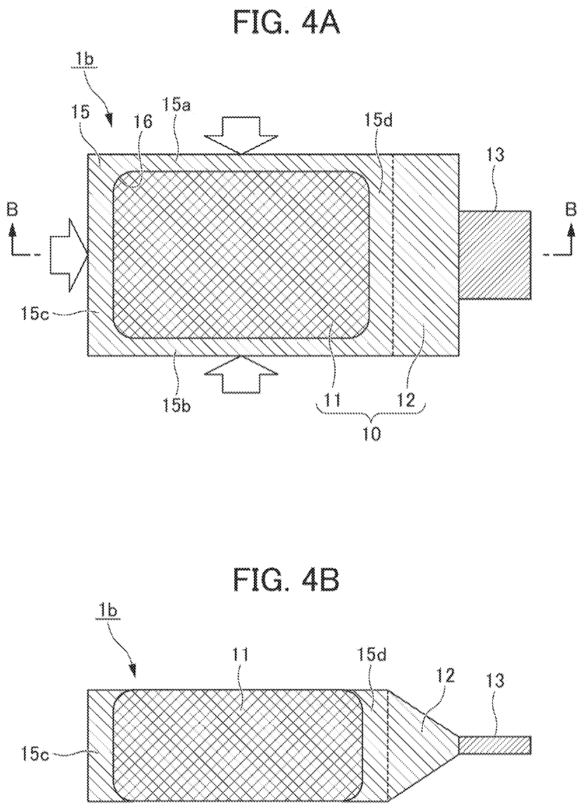

FIG. 3 is a cross-sectional schematic view according to a second embodiment of a lithium ion secondary battery of the present invention. In FIG. 4, FIG. 4A is a plan view of the positive electrode in FIG. 3, and FIG. 4B is a cross-sectional view along the line B-B in FIG. 4A. Hereinafter, configurations which are similar to the first embodiment are assigned the same reference number, and explanations thereof will be omitted.

This embodiment differs from the first embodiment in the point of the mixture non-filled region existing not only at the corners, but also the outer peripheral region of the collector. It is thereby possible to also mitigate the stress acting from the outer side of the outer peripheral region, in addition to corners of the collector, and possible to provide a solid-state battery of higher durability.

As shown in the negative electrode 1b of FIGS. 4A and B, the mixture non-filled region of this embodiment is formed into a peripheral shape with 15a, 15b, 15c, 15d over the four sides of the negative electrode 1b. As shown in FIG. 3A, the lithium ion secondary battery 200 is wrapped by outer packaging film 50, after stacking a plurality of electrode cells. In the case of assuming as on-board or the like, collision impact from a lateral side to the vehicle, or oscillations during rough road travel often act from the peripheral direction of the XY plane of the electrode, as external force that is the arrow directions in FIG. 3. At this time, the mixture non-filled regions 15a, 15b, 15c, 15d act as a circumferential buffer layer; therefore, it is possible to effectively prevent cracking of the electrode.

FIGS. 3 and 4 are examples in which the high modulus filler is not filled in the mixture non-filled regions 15a, 15b, 15c, 15d; however, the high modulus filler may be filled into the mixture non-filled regions 15a, 15b, 15c, 15d similarly to the first embodiment, also in the present embodiment.

In addition, the high modulus filler may be filled also into a space 51 between the outer packaging film 50 and the tab converging part 12 of the positive electrode 2, negative electrode 1.

### Third Embodiment

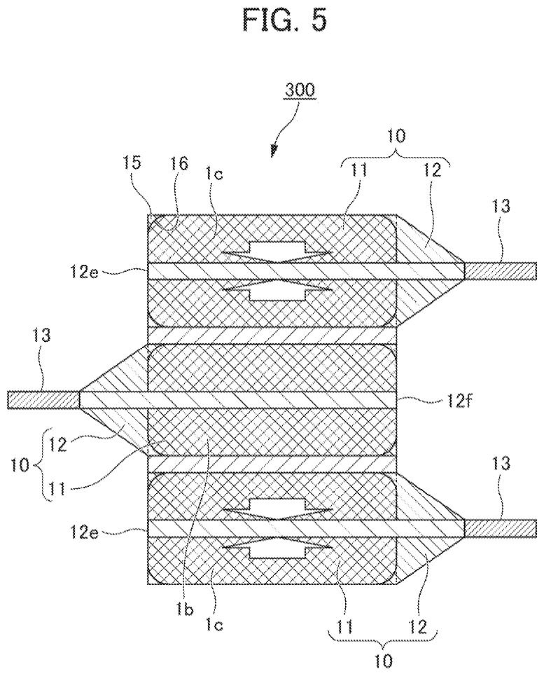

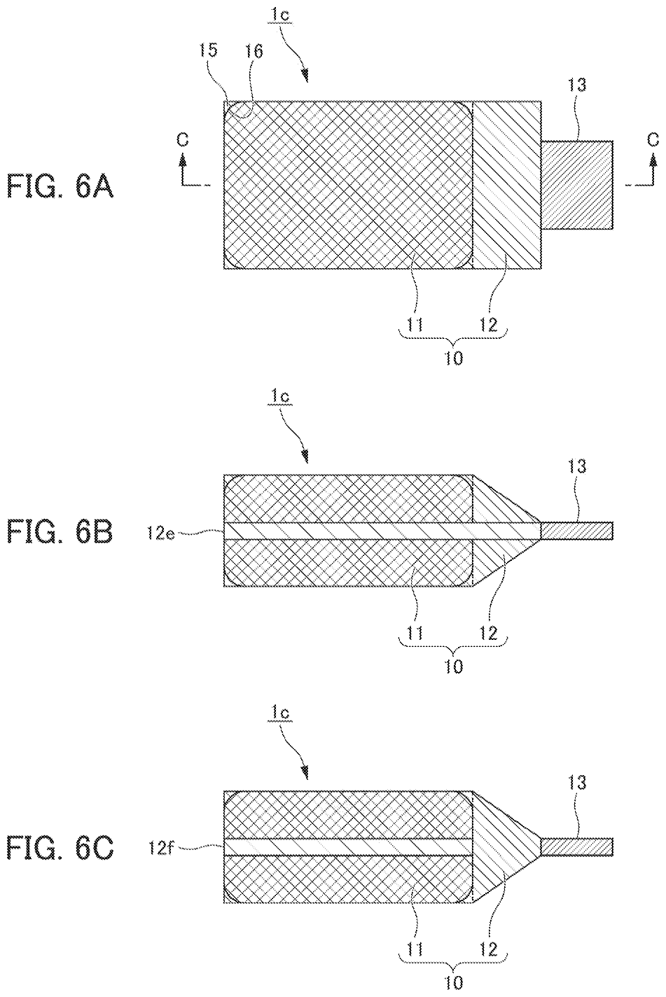

FIG. 5 is a cross-sectional schematic view according to a third embodiment of a lithium ion secondary battery of the present invention. In FIG. 6, FIG. 6A is a plan view of the positive electrode in FIG. 5, FIG. 6B is a cross-sectional view along the line C-C, and FIG. 6C is a modified example of a cross-sectional view along the line C-C.

This embodiment differs from the first embodiment in the point of the mixture existing not only at the corners, but also as an intermediate layer in the thickness direction of the collector. It is thereby possible to mitigate the stress acting from the outer surface thickness direction of the collector by the intermediate layer, in addition to the corners of the collector, and possible to provide a solid-state battery having higher durability.

As shown in the negative electrode 1c of FIG. 6, the mixture non-filled region of the lithium ion secondary battery 300 of this embodiment is also formed in the mixture non-filled region 15a as an intermediate layer, other than the mixture non-filled region 15 (25) of the corners. The intermediate layer is configured so as to exist in a planar form on the XY plane in a predetermined thickness, and to be sandwiched by the layers of the mixture filled regions 11 (21) above and below. This configuration can be formed by impregnating an electrode mixture of predetermined viscosity from the above and below directions of the collector.

The intermediate layer may be configured in the same shape and same area as the mixture filled region 11 (21) as in 15e of FIG. 6B, and may extend within the tab converging part 12 as in FIG. 6C. In addition, the intermediate layer may be arranged not only as one layer, but as any number of intermediate layers.

FIGS. 5 and 6 are examples in which the high modulus filler is not filled in the mixture non-filled regions 15, 15e, 15f; however, the high modulus filler may be filled into the mixture non-filled regions 15, 11e, 15f similarly to the first embodiment, also in the present embodiment.

As shown in FIG. 5, the lithium ion secondary battery 300 repeats volume expansion and contraction in the Z direction in the drawing upon repeating absorption and release of lithium. On this occasion, the mixture non-filled regions 15e, 15f of the intermediate layer play the role of a buffer layer such as shown that by the arrows in the drawings, and can effectively prevent cracking of electrodes.

Although preferred embodiments of the present invention have been explained above, the contents of the present invention are not to be limited to the above-mentioned embodiments, and modifications are possible where appropriate.

### EXPLANATION OF REFERENCE NUMERALS

1, 1b, 1c negative electrode
10 collector (negative electrode collector)
11 mixture filled region
12 tab converging part
13 tab
15 mixture non-filled region
15a, 15b, 15c, 15d mixture non-filled region
15e, 15f mixture non-filled region
16 curved surface part
18 electrode mixture (negative electrode mixture)
2, 2b, 2c positive electrode
20 collector (positive electrode collector)
21 mixture filled region
22 tab converging part
23 tab
25 mixture non-filled region
26 curved surface part
28 electrode mixture (positive electrode mixture)
4 solid electrolyte layer
51 space
V₁, V₂ pores
A corner
100, 200, 300 lithium ion secondary battery

What is claimed is:

1. An electrode for lithium ion secondary batteries, the electrode comprising:
a collector of a metal porous body having a predetermined thickness, and having a corner of at least one location in a stereoscopic view; and an electrode mixture filled Into pores of the metal porous body,
wherein the collector has a mixture filled region in which the electrode mixture is filled, and
a mixture non-filled region in which the electrode mixture is not filled, or a high modulus filler having an elastic modulus smaller than the electrode mixture is filled, existing at the corner of the electrode.

2. The electrode according to claim 1, wherein the mixture filled region makes a curved surface at the corner of the collector.

3. The electrode according to claim 1, wherein the high modulus filler is at least one selected from an insulating material, a reinforcing material and a thermal insulator.

4. The electrode according to claim 1, wherein the mixture non-filled region is also present at an outer peripheral region of the collector.

5. The electrode according to claim 1, wherein the mixture non-filled region is also present as an intermediate layer in the thickness direction of the collector.

6. A lithium ion secondary battery using the electrode according to claim 1 as a positive electrode and a negative electrode, wherein the positive electrode an electrolyte layer and the negative electrode are alternately arranged, and
wherein areas of the collectors which are adjacent and disposed to be opposing are substantially equal.
